(19) United States
(12) Patent Application Publication
(10) Pub. No.: US 2025/0279030 A1
(43) Pub. Date: Sep. 4, 2025

(54) DISPLAY DEVICE AND METHOD OF DRIVING THE SAME, AND ELECTRONIC DEVICE INCLUDING DISPLAY DEVICE

(71) Applicant: SAMSUNG DISPLAY CO., LTD., YONGIN-SI (KR)

(72) Inventors: Kang Hee LEE, Yongin-si (KR); Tong Ill KWAK, Yongin-si (KR); Ju Seo KIM, Yongin-si (KR); Jong Woong PARK, Yongin-si (KR); Jin Hwan CHO, Yongin-si (KR); Mi Young JOO, Yongin-si (KR)

(21) Appl. No.: 18/894,215

(22) Filed: Sep. 24, 2024

(30) Foreign Application Priority Data
Mar. 4, 2024 (KR) 10-2024-0030730

(51) Int. Cl. G09G 3/20; G09G 3/3233

(52) U.S. Cl. CPC G09G 3/2092; G09G 3/3233; G09G 2300/0819; G09G 2300/0842; G09G 2300/0861; G09G 2320/0233; G09G 2320/045

(57) ABSTRACT

A display device includes a display panel including a plurality of pixels, a degradation compensator circuit configured to generate compensation data that compensates for degradation of the pixels using a panel weight including characteristics of the display panel; and a timing controller configured to reflect the compensation data in input data and generate output data. The panel weight is generated based on fabrication data including a process variable of the display panel and module data including at least one characteristic of the pixels.

### CROSS-REFERENCE TO RELATED APPLICATIONS

This application claims priority under 35 U.S.C. § 119 to Korean Patent Application No. 10-2024-0030730, filed on Mar. 4, 2024, the disclosure of which is incorporated by reference herein in its entirety.

### TECHNICAL FIELD

Embodiments of the present disclosure relate to a display device, a method of driving the display device, and an electronic device including the display device.

### DISCUSSION OF RELATED ART

Display devices may include a data driver and a display panel. The display panel may include pixels. The data driver may provide data signals to the pixels through data lines. Each of the pixels may include a driving transistor and a light emitting element. The driving transistor may adjust the amount of current flowing through the pixel based on a data signal. The light emitting element may emit light at a luminance corresponding to the amount of current.

As the driving time of the display panel increases, the light emitting element and the driving transistor may degrade. For example, as the driving time increases, the luminance of light generated from the light emitting element may be reduced based on the same data signal. For example, as the driving time increases, the threshold voltage of the driving transistor may vary (or shift). Due to the degradation of the light emitting element and the driving transistor, the pixel may emit light at a luminance different from a desired luminance.

### SUMMARY

Embodiments of the present disclosure are directed to a display device, a method of driving the display device, and an electronic device including the display device capable of compensating for degradation of a light emitting element and a driving transistor included in each of pixels by accumulating input data and/or output data.

According to an embodiment of the present disclosure, a display device includes a display panel including a plurality of pixels, a degradation compensator circuit configured to generate compensation data that compensates for degradation of the pixels using a panel weight including at least one characteristic of the display panel, and a timing controller configured to reflect the compensation data in input data and generate output data. The panel weight is generated based on fabrication data including a process variable of the display panel and module data including at least one characteristic of the pixels.

In an embodiment, the fabrication data includes at least one of a deposition time and a cleaning time of each of materials forming the pixels, an aperture ratio of the pixels, a threshold voltage of a driving transistor included in each of the pixels, and a voltage range of a data signal set during a fabrication process.

In an embodiment, the module data includes color coordinates of the pixels, a leakage slope of a driving transistor included in each of the pixels, and a luminance of the pixels.

In an embodiment, the degradation compensator includes a degradation accumulator configured to generate accumulated data by accumulating at least one of the input data and the output data, and generate the compensation data using the accumulated data and the panel weight, and a memory configured to store the accumulated data and the panel weight.

In an embodiment, the degradation accumulator is configured to generate the accumulated data by accumulating at least one of the input data and the output data on a frame basis.

In an embodiment, the panel weight includes a first panel weight corresponding to estimated degradation dispersion information about a light emitting element included in at least one of the pixels, and a second panel weight corresponding to estimated degradation dispersion information about a driving transistor included in at least one of the pixels.

In an embodiment, the degradation accumulator is configured to generate a first stress compensation weight by reflecting the first panel weight in the accumulated data, and generate a second stress compensation weight by reflecting the second panel weight in the accumulated data. The first stress compensation weight and the second stress compensation weight are included in the compensation data.

In an embodiment, the timing controller includes a first compensator configured to generate first data by reflecting the first stress compensation weight in the input data, and a second compensator configured to generate the output data by reflecting the second stress compensation weight in the first data.

In an embodiment, the memory includes a first memory configured to store the accumulated data, and a second memory configured to store the first panel weight and the second panel weight.

In an embodiment, the first panel weight and the second panel weight correspond to each of the pixels.

In an embodiment, the display panel is divided into a plurality of blocks, each including at least two or more pixels. The first panel weight and the second panel weight correspond to each of the blocks.

In an embodiment, the first panel weight is a single panel weight, the single second panel weight is a single panel weight, and the first panel weight and the second panel weight correspond to all of the pixels.

In an embodiment, the memory is configured to store a plurality of panel weights corresponding to different types of display panels. The degradation compensator circuit further includes a controller configured to supply at least one panel weight among the plurality of panel weights to the degradation accumulator based on the fabrication data including the process variable of the display panel and the module data including the at least one characteristic of the pixels.

In an embodiment, the display device further includes a scan driver configured to supply a scan signal to the pixels, and a data driver configured to generate a data signal using the output data, and supply the data signal to the pixels.

According to an embodiment of the present disclosure, a display device includes a display panel including a plurality of pixels, and a degradation compensator circuit configured to generate compensation data that compensates for degradation of the pixels. The degradation compensator circuit is configured to generate accumulated data by accumulating at least one of input data and output data, and generate compensation data by reflecting, in the accumulated data, a first panel weight corresponding to estimated degradation dispersion information about a light emitting element included in each of the pixels and a second panel weight corresponding to estimated degradation dispersion information about a driving transistor included in each of the pixels.

In an embodiment, the compensation data includes a first stress compensation weight in which the first panel weight is reflected, and a second stress compensation weight in which the second panel weight is reflected.

In an embodiment, the display device further includes a timing controller configured to generate the output data using the input data. The timing controller includes a first compensator configured to generate first data by reflecting the first stress compensation weight in the input data, and a second compensator configured to generate the output data by reflecting the second stress compensation weight in the first data.

In an embodiment, the degradation compensator circuit further includes a memory in which the accumulated data, the first panel weight, and the second panel weight are stored.

According to an embodiment of the present disclosure, a method of driving a display device includes generating accumulated data by accumulating at least one of input data and output data, generating a first stress compensation weight by reflecting a first panel weight including at least one characteristic of a display panel in the accumulated data, generating a second stress compensation weight by reflecting a second panel weight including the at least one characteristic of the display panel in the accumulated data, generating first data by reflecting the first stress compensation weight in the input data, and generating the output data by reflecting the second stress compensation weight in the first data.

In an embodiment, the first panel weight corresponds to estimated degradation dispersion information about a light emitting element included in a pixel, and the second panel weight corresponds to estimated degradation dispersion information about a driving transistor included in the pixel.

In an embodiment, the method further includes generating a data signal using the output data.

According to an embodiment of the present disclosure, an electronic device includes a display panel including a plurality of pixels, a controller configured to control the display panel, and a data conversion circuit configured to generate accumulated data by accumulating at least one of input data inputted to the controller and output data outputted from the controller, and generate compensation data by reflecting a panel weight including characteristic information of the display panel in the accumulated data. The controller is further configured to generate the output data by reflecting the compensation data in the input data.

In an embodiment, the panel weight includes a first panel weight corresponding to estimated degradation dispersion information about a light emitting element included in each of the pixels, and a second panel weight corresponding to estimated degradation dispersion information about a driving transistor included in each of the pixels.

### BRIEF DESCRIPTION OF THE DRAWINGS

The above and other features of the present disclosure will become more apparent by describing in detail embodiments thereof with reference to the accompanying drawings.

FIG. 1 is a diagram illustrating a display device in accordance with an embodiment of the present disclosure.

FIG. 2 is a diagram illustrating degradation characteristics of a driving transistor for each display panel.

FIG. 3 is a diagram illustrating degradation characteristics of a light emitting element for each display panel.

FIGS. 4A and 4B are diagrams illustrating an embodiment of a pixel component.

FIG. 5 is a diagram illustrating a degradation compensator and a timing controller in accordance with an embodiment of the present disclosure.

FIG. 6 is a flowchart showing an operation process of the degradation compensator and the timing controller illustrated in FIG. 5.

FIG. 7 is a diagram illustrating a degradation compensator and a timing controller in accordance with an embodiment of the present disclosure.

FIG. 8 is a diagram illustrating a degradation compensator and a timing controller in accordance with an embodiment of the present disclosure.

FIG. 9 is a diagram illustrating an example of a pixel shown in FIG. 1.

FIG. 10 is a diagram for describing a method of driving the pixel shown in FIG. 9 according to an example.

FIG. 11 is a diagram illustrating an electronic device in accordance with an embodiment of the present disclosure.

### DETAILED DESCRIPTION

Embodiments of the present disclosure will be described more fully hereinafter with reference to the accompanying drawings. Like reference numerals may refer to like elements throughout the accompanying drawings.

In the drawings, portions which are not related to the present disclosure may be omitted for convenience of explanation.

Some embodiments are described in the accompanying drawings in connection with functional blocks, units and/or modules. Those skilled in the art will understand that such blocks, units, and/or modules are physically implemented by logic circuits, discrete components, microprocessors, hard-wired circuits, memory elements, line connections, and other electronic circuits. This may be formed using semiconductor-based fabrication techniques or other fabrication techniques. For blocks, units, and/or modules implemented by a microprocessor or other similar hardware, they may be programmed and controlled using software to perform various functions discussed herein, and may be optionally driven by firmware and/or software. In addition, each block, unit, and/or module may be implemented by dedicated hardware, or be implemented by a combination of the dedicated hardware which performs some functions and a processor which performs different functions (e.g., one or more programmed microprocessors and related circuits). Furthermore, in some embodiments, blocks, units and/or modules may be physically separated into two or more individual blocks, units and/or modules which interact with each other without departing from the scope of the present disclosure. In some embodiments, blocks, units and/or modules may be physically combined into more complex blocks, units and/or modules without departing from the scope of the inventive concept.

The term “connection” between two components may embrace electrical connection and physical connection, but the present disclosure is not limited thereto. For example, the term “connection” used in description with reference to a circuit diagram may refer to electrical connection, and the term “connection” used in description with reference to a cross-sectional view or a plan view may refer to physical connection.

It will be understood that, although the terms “first”, “second”, etc. may be used herein to describe various elements, these elements should not be limited by these terms. These terms are only used to distinguish one element from another element. For example, a first element described below could be termed a second element without departing from the teachings of the present disclosure.

Herein, when two or more elements or values are described as being substantially the same as or about equal to each other, it is to be understood that the elements or values are identical to each other, the elements or values are equal to each other within a measurement error, or if measurably unequal, are close enough in value to be functionally equal to each other as would be understood by a person having ordinary skill in the art. For example, the term “about” as used herein is inclusive of the stated value and means within an acceptable range of deviation for the particular value as determined by one of ordinary skill in the art, considering the measurement in question and the error associated with measurement of the particular quantity (e.g., the limitations of the measurement system). For example, “about” may mean within one or more standard deviations as understood by one of the ordinary skill in the art. Further, it is to be understood that while parameters may be described herein as having “about” a certain value, according to embodiments, the parameter may be exactly the certain value or approximately the certain value within a measurement error as would be understood by a person having ordinary skill in the art. Other uses of these terms and similar terms to describe the relationships between components should be interpreted in a like fashion.

The present disclosure is not limited to the following embodiments and may be modified into various forms. Each embodiment to be described below may be implemented alone, or combined with at least another embodiment to make various combinations of embodiments.

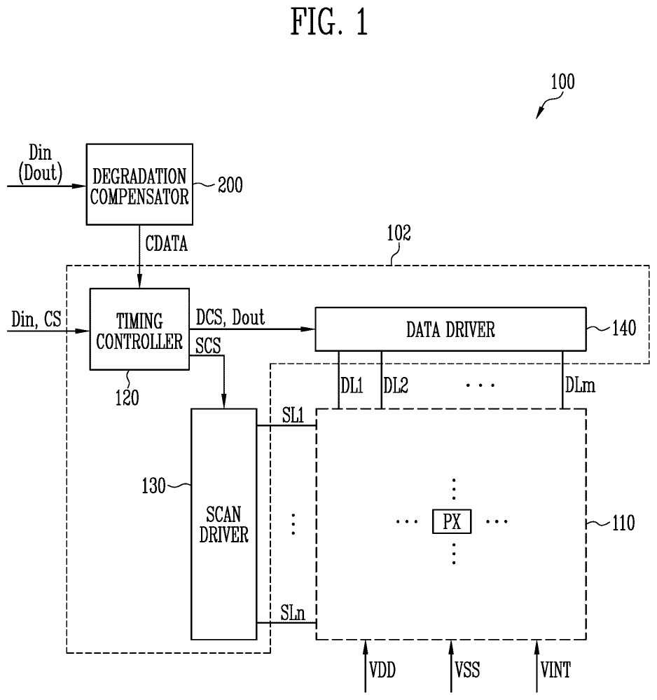

FIG. 1 is a diagram illustrating a display device 100 in accordance with an embodiment of the present disclosure.

Referring to FIG. 1, the display device 100 in accordance with an embodiment of the present disclosure may include a pixel component 110 (also referred to as a display panel), a panel driver 102 (also referred to as a panel driver circuit), and a degradation compensator 200 (also referred to as a degradation compensator circuit).

The display device 100 may be employed in electronic devices such as, for example, a computer, a laptop, a cellular phone, a smartphone, a personal digital assistants (PDA), a potable multimedia player (PMP), a digital TV, a digital camera, a portable game console, a navigation device, a wearable device, an Internet of Things (IoT) device, an Internet of Everything (IoE) device, an e-book, a virtual reality (VR) device, an augmented reality (AR) device, a navigation device for vehicles, a videophone, a monitoring system, an automatic focus system, a tracking system, and a motion sensor system.

The pixel component 110 may include a plurality of pixels PX formed in areas partitioned by scan lines SL1 to SLn and data lines DL1, DL2, . . . , DLm (where n and m are each a positive integer of 3 or more). Each of the pixels PX may include a driving transistor and a light emitting element.

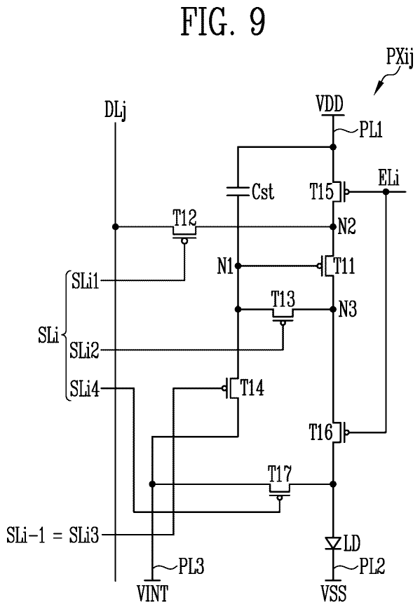

For example, a pixel PXij (refer to FIG. 9) positioned on an i-th horizontal line (or a pixel row) and a j-th vertical line (or a pixel column) may be connected to an i-th scan line SLi, and a j-th data line DLj (where i is a positive integer of n or less, and j is a positive integer of m or less). The pixels PX may be selected on a horizontal line basis (e.g., pixels PX connected to the same scan line may be grouped into one horizontal line (or a pixel row)) when a scan signal is supplied to the scan lines SL1 to SLn. Each of the pixels PX that are selected by the scan signal may receive a data signal from a corresponding data line (any one of DL1 to DLm) connected therewith.

The driving transistor included in each of the pixels PX may control the amount of current supplied to the light emitting element in response to the data signal. The light emitting element may emit light at a luminance corresponding to the amount of current.

In an embodiment, each of the pixels PXL may include a plurality of sub-pixels. Each of the sub-pixels may emit light in one color of, for example, red, green, and blue. However, the aforementioned example is only for illustrative purposes, and each of the sub-pixels may emit light of a color such as, for example, cyan, magenta, and yellow.

In an embodiment, the panel driver 102 may include a timing controller 120 (also referred to as a timing controller circuit), a scan driver 130 (also referred to as a scan driver circuit), and a data driver 140 (also referred to as a data driver circuit). The components included in the panel driver 102 may be implemented as separate integrated circuits. Two or more components of the aforementioned components may be implemented into a single integrated circuit. The scan driver 130 may be formed in the pixel component 110.

The scan driver 130 may receive a scan driving signal SCS from the timing controller 120. The scan driving signal SCS may include at least one scan start signal and clock signals utilized to drive the scan driver 130. The scan driver 130 may generate a scan signal while shifting the scan start signal in response to a clock signal. The scan driver 130 may include a plurality of scan drivers so that scan signals can be supplied at different timings in the same horizontal period, in correspondence with circuit structures of the pixels PX.

The data driver 140 may receive output data Dout and a data driving signal DCS from the timing controller 120. The data driving signal DCS may include a sampling signal and/or timing signals utilized to drive the data driver 140. The data driver 140 may generate analog data signals, based on the data driving signal DCS and the output data Dout. The data driver 140 may supply data signals in units of one horizontal period.

The timing controller 120 may receive input data Din and a control signal CS from a host system through an interface. For example, the timing controller 120 may receive input data Din and a control signal CS from at least one of a graphics processing unit (GPU), a central processing unit (CPU), and an application processor (AP) that are included in the host system. The control signal CS may include various signals including a clock signal.

The timing controller 120 may generate a scan driving signal SCS and a data driving signal DCS, based on the control signal CS. The scan driving signal SCS and the data driving signal DCS may be respectively supplied to the scan driver 130 and the data driver 140.

The timing controller 120 may generate output data Dout by reflecting compensation data CDATA in the input data Din. Here, the compensation data CDATA may be set to compensate for degradation of the light emitting element and the driving transistor included in each of the pixels PX. The output data Dout may be provided to the data driver 140.

In an embodiment, the panel driver 102 may include a power supply configured to generate first driving power VDD, second driving power VSS, and initialization power VINT so as to drive the pixel component 110.

The degradation compensator 200 may generate accumulated data (or lifespan data) by accumulating the input data Din and/or the output data Dout. Hereinafter, for convenience of explanation, it is assumed that the degradation compensator 200 uses the input data Din to generate the accumulated data.

The degradation compensator 200 may generate compensation data CDATA by reflecting a panel weight in the accumulated data. The panel weight may be a value in which the characteristics of the display panel (e.g., the pixel component 110) included in the display device 100 is reflected. The compensation data CDATA may be supplied to the timing controller 120.

In an embodiment, the degradation compensator 200 may be implemented as a separate application processor (AP). In an embodiment, at least some or all components of the degradation compensator 200 may be included in the timing controller 120. In an embodiment, the degradation compensator 200 may be included in an IC including the data driver 140.

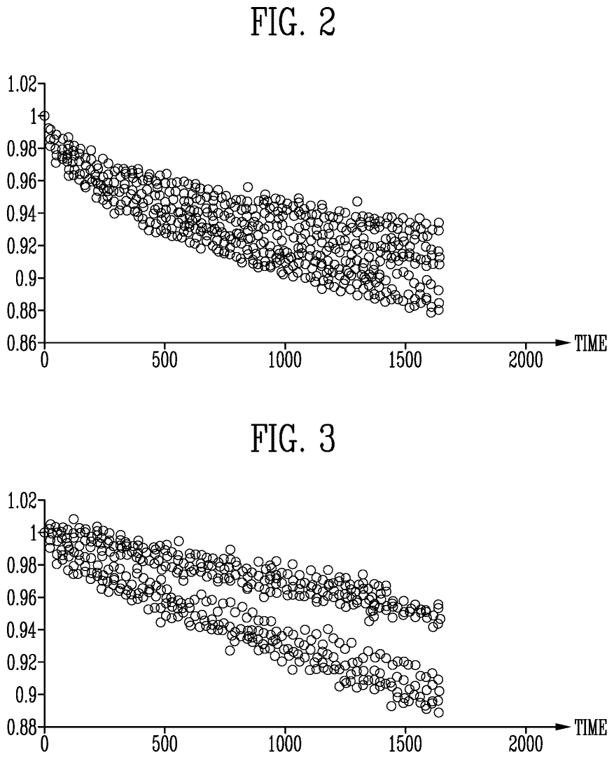

FIG. 2 is a diagram illustrating degradation characteristics of the driving transistor for each display panel. In FIG. 2, the Y-axis refers to a current retention rate, and represents a case in which the driving current is set to “1” when the driving transistor is not degraded. In FIG. 2, the X-axis refers to time.

Referring to FIG. 2, over the driving time of the display device 100, the driving transistor may be degraded, thus leading to a decrease in driving current. Here, the characteristics of the driving transistors included in the respective display panels may be set to be different from each other. For example, the driving transistors included in different panels may have different current retention rates based on the same driving time.

As such, in a case in which the degradation characteristics of the driving transistors for the respective display panels are set to be different from each other, it may be difficult to accurately compensate for the degradation of the driving transistors included in different display panels using only accumulated data. In an embodiment of the present disclosure, compensation data CDATA may be generated by reflecting, in the accumulated data, the panel weight in which the characteristics (or characteristic information) of the display panel is reflected. Accordingly, the degradation of the driving transistor in each of the display panels may be reliably compensated for.

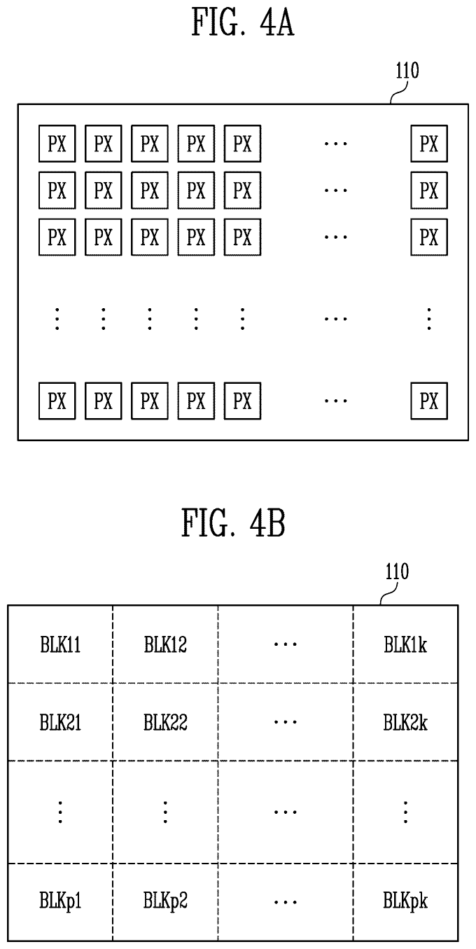

FIG. 3 is a diagram illustrating degradation characteristics of the light emitting element for each display panel.

In FIG. 3, the Y-axis refers to a luminance retention rate, and represents a case in which the luminance is set to “1” when the light emitting element included in a specific display panel is not degraded. In FIG. 3, the X-axis refers to time. FIGS. 4A and 4B are diagrams illustrating an embodiment of the pixel component.

Referring to FIG. 3, over the driving time of the display device 100, the light emitting element may be degraded, thus leading to a decrease in luminance of the light emitting element. Here, the characteristics of the light emitting elements included in the respective display panels may be set to be different from each other. For example, the light emitting elements included in different panels may have different luminance retention rates based on the same driving time.

As such, in a case in which the degradation characteristics of the light emitting elements for the respective display panels are set to be different from each other, it may be difficult to accurately compensate for the degradation of the light emitting elements included in different display panels using only accumulated data. In an embodiment of the present disclosure, compensation data CDATA may be generated by reflecting, in the accumulated data, the panel weight in which the characteristics of the display panel are reflected. Accordingly, the degradation of the light emitting element in each of the display panels may be reliably compensated for.

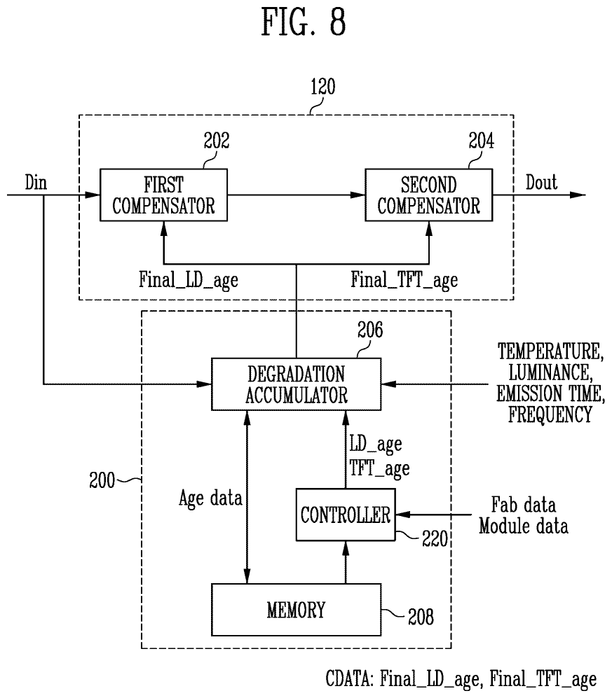

The current retention rate of the driving transistor and the luminance retention rate of the light emitting element may be determined by fabrication data (Fab data; refer to FIG. 8) and module data (Module data; refer to FIG. 8).

The Fab data may include a process variable. Here, the process variable may include at least one of a deposition time and a cleaning time of each of materials forming the pixel, an aperture ratio of the pixels PX, a threshold voltage of the driving transistor, and a voltage range of a data signal set during a fabrication process. The process variable may include various pieces of additional information and, for example, may include an environmental variable (e.g., temperature, etc.).

The module data may include characteristic information of the pixels. The module data may be measured after various components including the panel driver 102 are combined with pixels that have undergone a fabrication process. The module data may include at least one of color coordinates of the pixels PX, a leakage slope (Lslope) of the driving transistor, and luminance of the pixels PX. The Lslope of the driving transistor may refer to variance in leakage current depending on a change of about 10 mV in threshold voltage. The module data may include various pieces of additional information and, for example, may include a voltage range of the data signal. The voltage of the data signal set during the fabrication process and the voltage of the data signal actually measured after the module is assembled may be different from each other. Accordingly, the voltage range of the data signal may be included in each of the Fab data and the module data.

In a case in which different display panels have similar (or substantially identical) Fab data and module data, the respective light emitting elements and the respective driving transistors included in the display panels may have similar degradation dispersion. For example, in a case in which different display panels have similar (or substantially identical) Fab data and module data, the luminance retention rates of the respective light emitting elements included in the display panels and the current retention rates of the respective driving transistors may be set to be similar to each other.

In a case in which different display panels have different Fab data and module data, the respective light emitting elements and the respective driving transistors included in the display panels may have different degradation dispersions. For example, in a case in which different display panels have different Fab data and module data, the luminance retention rates of the respective light emitting elements included in the display panels and the current retention rates of the respective driving transistors may be set to be different from each other.

An embodiment of the present disclosure may implement a method of estimating the characteristics of the light emitting element and the driving transistor using the Fab data and the module data of the display panel. First, the current retention rate of the driving transistor (or the degradation dispersion of the driving transistor) and the luminance retention rate of the light emitting element (or the degradation dispersion of the light emitting element) may be measured for each of a plurality of display panels having various conditions (e.g., different Fab data and module data).

In an embodiment, the current retention rate of the driving transistor and the luminance retention rate of the light emitting element may be measured on a basis of the pixel of each of the display panels, as illustrated in FIG. 4A. In an embodiment, the current retention rate of the driving transistor and the luminance retention rate of the light emitting element may be measured on a basis of a block BLK11, BLK12, . . . , BLK1k, BLK21, BLK22, . . . , BLK2k, BLKp1, BLKp2, . . . , BLKpk (where k and p are each a positive integer of 3 or more) of each of the display panels, as illustrated in FIG. 4B. The block may include at least two or more pixels PX. In an embodiment, the current retention rate of the driving transistor and the luminance retention rate of the light emitting element may be measured on a display panel basis (e.g., an average value of all pixels PX included in the pixel component 110).

Information on the current retention rate of the driving transistor and the luminance retention rate of the light emitting element for each display panel may be modeled corresponding to a plurality of pieces of Fab data and a plurality of pieces of module data. The degradation dispersion of the driving transistor included in a specific display panel and the degradation dispersion of the light emitting element may be estimated using the modeled information. For example, the degradation dispersion of the driving transistor and the degradation dispersion of the light emitting element may be estimated using the Fab data and the module data of the specific display panel. The estimated degradation dispersion information about the driving transistor and the estimated degradation dispersion information about the light emitting element may refer to the aforementioned panel weights.

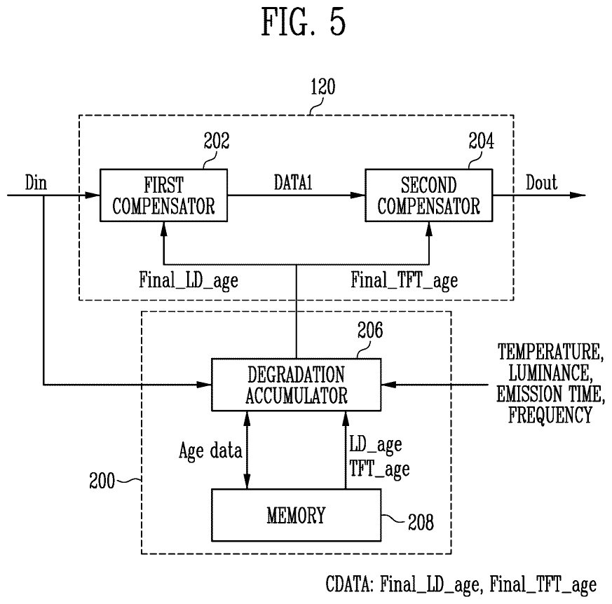

FIG. 5 is a diagram illustrating the degradation compensator 200 and the timing controller 120 in accordance with an embodiment of the present disclosure. In FIG. 5, for convenience of illustration, only components among various components included in the timing controller 120 relating to the below description are illustrated.

Referring to FIG. 5, the degradation compensator 200 in accordance with an embodiment of the present disclosure may include a degradation accumulator 206 (also referred to as a degradation accumulator circuit) and a memory 208.

The degradation accumulator 206 may generate accumulated data Age data (or lifespan data) by accumulating the input data Din. The degradation accumulator 206 may generate accumulated data Age data by accumulating the input data Din on a frame basis. However, embodiments of the present disclosure are not limited to the aforementioned example. For example, in an embodiment, the degradation accumulator 206 may generate accumulated data Age data by accumulating the output data Dout. In an embodiment, the degradation accumulator 206 may generate the accumulated data Age data by additionally reflecting the temperature of the display panel, the luminance of the pixels PX, the emission time of the pixels PX, the driving frequency of the display panel, etc.

In an embodiment, as illustrated in FIG. 4A, the degradation accumulator 206 may generate the accumulated data Age data corresponding to each of the pixels PX included in the display panel (or the pixel component 110), e.g., for each pixel. In an embodiment, as illustrated in FIG. 4B, the degradation accumulator 206 may generate accumulated data Age data for each of the blocks BLK11 to BLKpk included in the display panel (or the pixel component 110). The accumulated data Age data generated by the degradation accumulator 206 may be stored in the memory 208.

The accumulated data Age data supplied from the degradation accumulator 206 may be stored in the memory 208. A panel weight, for example, a first panel weight LD_age and a second panel weight TFT_age, may be stored in the memory 208.

The first panel weight LD_age may refer to estimated degradation dispersion information about the light emitting element corresponding to the Fab data and the module data of a specific display panel to which the degradation compensator 200 is attached. The first panel weight LD_age corresponding to each of the pixels PX may be pre-stored in the memory 208. The first panel weight LD_age may be pre-stored in the memory 208 on a basis of the blocks BLK11 to BLKpk. The first panel weight LD_age may be stored in the memory 208 in such a way that only one value is stored in the memory 208, corresponding to all of the pixels PX included in the display panel.

The second panel weight TFT_age may refer to estimated degradation dispersion information about the driving transistor corresponding to the Fab data and the module data of a specific display panel to which the degradation compensator 200 is attached. The second panel weight TFT_age corresponding to each of the pixels PX may be pre-stored in the memory 208. The second panel weight TFT_age may be pre-stored in the memory 208 on a basis of the blocks BLK11 to BLKpk. The second panel weight TFT_age may be stored in the memory 208 in such a way that only one value is stored in the memory 208, corresponding to all of the pixels PX included in the display panel.

The degradation accumulator 206 may receive the input data Din, and generate a first stress compensation weight Final_LD_age by reflecting the first panel weight LD_age in the accumulated data Age data corresponding to the input data Din. The degradation accumulator 206 may receive the input data Din, and generate a second stress compensation weight Final_TFT_age by reflecting the second panel weight TFT_age in the accumulated data Age data corresponding to the input data Din. The first stress compensation weight Final LD_age and the second stress compensation weight Final_TFT_age may be supplied to the timing controller 120 as the compensation data CDATA.

The timing controller 120 may include a first compensator 202 (also referred to as a first compensator circuit) and a second compensator 204 (also referred to as a second compensator circuit).

The first compensator 202 may compensate for degradation of the light emitting elements included in the pixels PX. The first compensator 202 may receive the input data Din from an external device, and may receive the first stress compensation weight Final_LD_age from the degradation accumulator 206. The first compensator 202 may generate first data DATA1 by reflecting the first stress compensation weight Final LD_age in the input data Din. The first data DATA1 generated from the first compensator 202 may be supplied to the second compensator 204.

The second compensator 204 may compensate for degradation of the driving transistors included in the pixels PX. The second compensator 204 may receive the first data DATA1 from the first compensator 202, and may receive the second stress compensation weight Final_TFT_age from the degradation accumulator 206. The second compensator 204 may generate the output data Dout by reflecting the second stress compensation weight Final_TFT_age in the first data DATA1. The output data Dout generated from the second compensator 204 may be supplied to the data driver 140.

The degradation compensator 200 in accordance with an embodiment of the present disclosure may generate the compensation data CDATA (e.g., the first stress compensation weight Final_LD_age and the second stress compensation weight Final_TFT_age) by reflecting the panel weights LD_age and TFT_age in the accumulated data Age data. For example, in an embodiment of the present disclosure, the compensation data CDATA may be generated by reflecting the estimated degradation dispersion information about the light emitting element and the estimated degradation dispersion information about the driving transistor. Accordingly, the degradation of the pixels PX may be reliably compensated for.

For example, in an embodiment of the present disclosure, the degradation of the pixels PX may be compensated for without sensing current from the pixels PX. For example, in an embodiment of the present disclosure, an operation of sensing current from the pixels PX may be added. However, compared to a case in which the panel weight is not reflected, the number of times of current sensing may be reduced.

At least one additional component may be disposed between the first compensator 202 and the second compensator 204. For example, various additional known components included in the timing controller 120 may be disposed between the first compensator 202 and the second compensator 204.

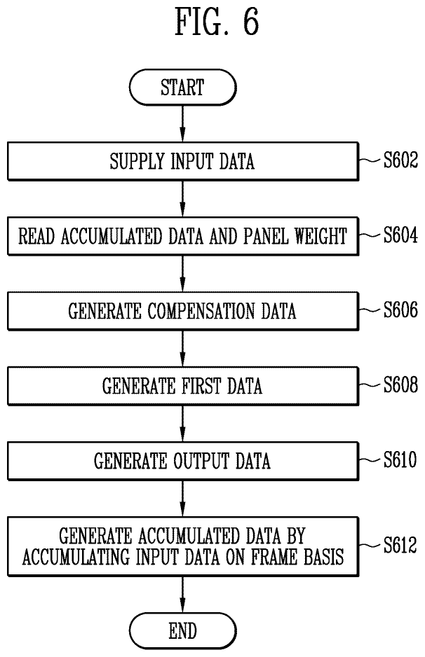

FIG. 6 is a flowchart showing an operation process of the degradation compensator and the timing controller illustrated in FIG. 5.

Referring to FIG. 6, the input data Din is supplied from an external device to the first compensator 202 and the degradation accumulator 206 (at operation S602). The degradation accumulator 206 supplied with the input data Din reads the accumulated data Age data and the panel weights LD_age and TFT_age corresponding to the input data Din (e.g., for the same pixel or the same block) from the memory 208 (at operation S604).

The panel weights LD_age and TFT_age may include the first panel weight LD_age corresponding to the estimated degradation dispersion information about the light emitting element, and the second panel weight TFT_age corresponding to the estimated degradation dispersion information about the driving transistor. The degradation accumulator 206 may generate the compensation data CDATA by reflecting the panel weights LD_age and TFT_age in the input data Din (at operation S606). The compensation data CDATA may include the first stress compensation weight Final_LD_age for compensating for degradation of the light emitting element, and the second stress compensation weight Final_TFT_age for compensating for degradation of the driving transistor.

The first compensator 202 may generate the first data DATA1 by reflecting the first stress compensation weight Final_LD_age in the input data Din (at operation S608). The second compensator 204 may generate the output data Dout by reflecting the second stress compensation weight Final_TFT_age in the first data DATA1 (at operation S610).

The output data Dout generated from the second compensator 204 may be supplied to the data driver 140. The data driver 140 may generate a data signal based on the output data Dout, and supply the generated data signal to the pixels PX.

The degradation accumulator 206 may generate the accumulated data Age data by accumulating the input data Din (and/or the output data Dout) on a frame basis, and store the generated accumulated data Age data in the memory 208 (at operation S612).

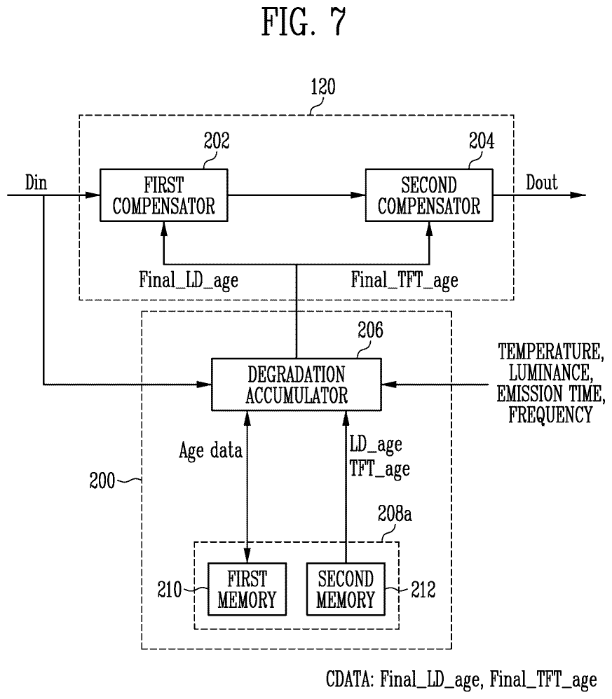

FIG. 7 is a diagram illustrating a degradation compensator 200 and a timing controller 120 in accordance with an embodiment of the present disclosure. In the following description of FIG. 7, the same reference numerals will be used to designate the same components as those of FIG. 5, and for convenience of explanation, redundant explanation thereof will be omitted.

Referring to FIG. 7, the degradation compensator 200 in accordance with an embodiment of the present disclosure may include a degradation accumulator 206 and a memory 208a.

The memory 208a may include a first memory 210 and a second memory 212. The accumulated data Age data may be stored in the first memory 210. The first panel weight LD_age and the second panel weight TFT_age may be stored in the second memory 212. For example, the general configuration of an embodiment of FIG. 7, other than the structure in which there are provided the first memory 210 for storing the accumulated data Age data and the second memory 212 for storing the panel weights LD_age and TFT_age, may be the same as that of FIG. 5.

FIG. 8 is a diagram illustrating a degradation compensator 200 and a timing controller 120 in accordance with an embodiment of the present disclosure. In the following description of FIG. 8, the same reference numerals will be used to designate the same components as those of FIG. 5, and for convenience of explanation, redundant explanation thereof will be omitted.

Referring to FIG. 8, the degradation compensator 200 in accordance with an embodiment of the present disclosure may include a degradation accumulator 206, a memory 208, and a controller 220.

The accumulated data Age data may be stored in the memory 208. A plurality of panel weights LD_age and a plurality of second panel weights TFT_age that correspond to a plurality of display panels may be stored in the memory 208.

The controller 220 may be positioned between the degradation accumulator 206 and the memory 208. The controller 220 may receive, from an external device (for example, the timing controller 120), Fab data and module data of a specific panel to which the degradation compensator 200 is attached. The controller 220 that has received the Fab data and the module data may supply the first panel weight LD_age and the second panel weight TFT_age corresponding to the Fab data and the module data to the degradation accumulator 206.

FIG. 9 is a diagram illustrating an example of the pixel illustrated in FIG. 1.

Referring to FIG. 9, a pixel PXij in accordance with an embodiment of the present disclosure may include transistors T11, T12, T13, T14, T15, T16, and T17, a storage capacitor Cst, and a light emitting element LD.

Hereinafter, a circuit configured of P-type transistors will be described by way of example. However, embodiments of the present disclosure are not limited thereto. For example, in an embodiment, a circuit may be configured of N-type transistors by changing the polarity of the voltage to be applied to a gate terminal of each transistor. Further, in an embodiment, a circuit may be configured of a combination of P-type transistors and N-type transistors. Each transistor may be configured in various forms such as, for example, a thin film transistor (TFT), a field effect transistor (FET), and a bipolar junction transistor (BJT).

The transistor T11 may include a gate electrode connected to a first node N1, a first electrode connected to a second node N2, and a second electrode connected to a third node N3. The transistor T11 may be referred to as a driving transistor.

The transistor T12 may include a gate electrode connected to a scan line SLi1, a first electrode connected to a data line DLj, and a second electrode connected to the second node N2. The transistor T13 may include a gate electrode connected to a scan line SLi2, a first electrode connected to the first node N1, and a second electrode connected to the third node N3.

The transistor T14 may include a gate electrode connected to a scan line SLi3, a first electrode connected to the first node N1, and a second electrode connected to a third power line PL3. The transistor T15 may include a gate electrode connected to an emission control line ELi, a first electrode connected to a first power line PL1, and a second electrode connected to the second node N2.

The transistor T16 may include a gate electrode connected to the emission control line ELi, a first electrode connected to the third node N3, and a second electrode connected to an anode of the light emitting element LD. In an embodiment, the transistor T15 and the transistor T16 may be connected to different emission control lines.

The transistor T17 may include a gate electrode connected to a scan line SLi4, a first electrode connected to the third power line PL3, and a second electrode connected to the anode of the light emitting element LD. The storage capacitor Cst may include a first electrode connected to the first power line PL1, and a second electrode connected to the first node N1.

The light emitting element LD may include the anode connected to the second electrode of the transistor T16, and a cathode connected to a second power line PL2. The light emitting element LD may be a light emitting diode. The light emitting element LD may be formed of, for example, an organic light emitting diode, an inorganic light emitting diode, a quantum dot/well light emitting diode, etc. The light emitting element LD may emit light in any one color of a first color, a second color, and a third color. Although an embodiment described with reference to FIG. 9 only includes one light emitting element LD provided in each pixel, embodiments are not limited thereto. For example, in an embodiment, a plurality of light emitting elements may be provided in each pixel. Here, the plurality of light emitting elements may be connected in series, parallel, series-parallel, etc.

A voltage of the first driving power VDD may be applied to the first power line PL1. A voltage of the second driving power VSS may be applied to the second power line PL2. A voltage of the initialization power VINT may be applied to the third power line PL3. For example, the voltage of the initialization power VINT may be substantially identical to or greater than the voltage of the second driving power VSS. For example, the voltage of the initialization power VINT may be substantially identical to or less than the lowest data voltage among voltages of available data signals.

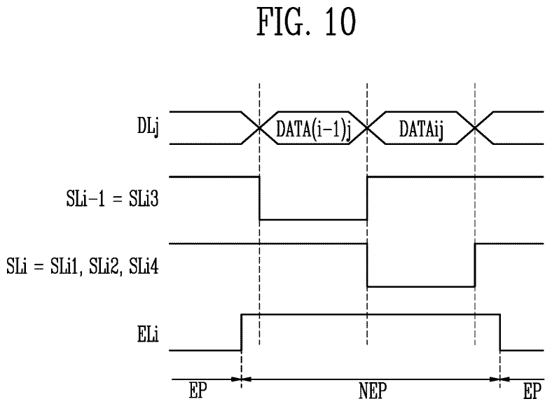

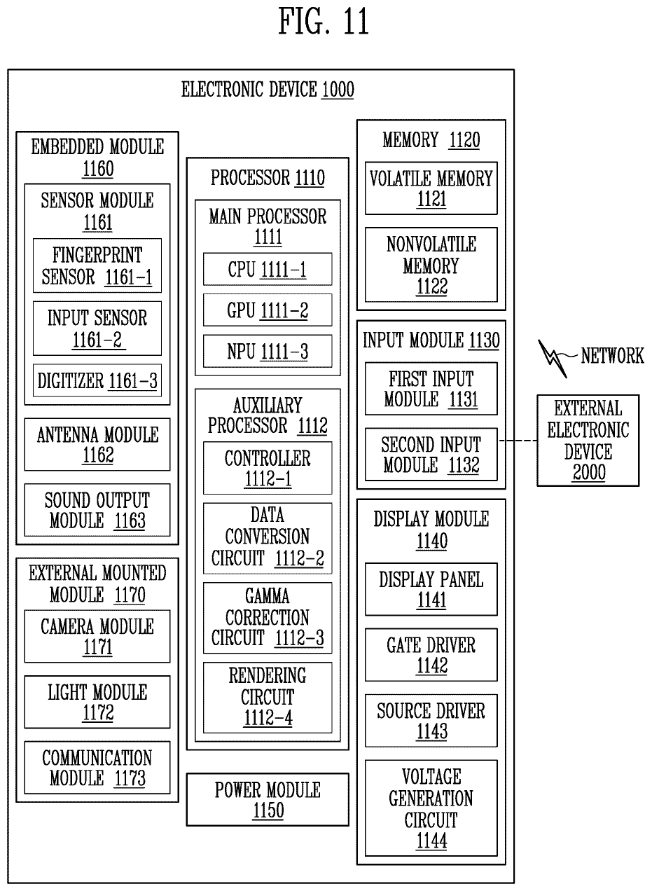

FIG. 10 is a diagram for describing a method of driving the pixel shown in FIG. 9 according to an example.

Hereinafter, for convenience of explanation, it is assumed that the scan lines SLi1, SLi2, and SLi4 refer to an i-th scan line SLi, and the scan line SLi3 is an i-1-th scan line SLi-1. Here, a connection relationship between the scan lines SLi1, SLi2, SLi3, and SLi4 may be changed in various ways depending on embodiments. For example, the scan line SLi4 may be an i-1-th scan line or an i+1-th scan line.

First, an emission signal having a turn-off level (a logic high level) may be applied to the i-th emission control line ELi. A data signal DATA(i-1)j for an i-1-th pixel may be applied to the data line DLj. A scan signal having a turn-on level (a logic low level) may be applied to the scan line SLi3. Whether the logic level is high or low may be changed depending on whether the transistor is of a P-type or an N-type.

Here, because a scan signal having a turn-off level is applied to the scan lines SLi1 and SLi2, the transistor T12 is turned off, so that the data signal DATA(i-1)j for the i-1-th pixel may be prevented from being drawn into the pixel PXij.

Here, because the transistor T14 is turned on, the first node N1 is connected to the third power line PL3, and the first node N1 is initialized to the voltage of the initialization power VINT. Because an emission control signal having a turn-off level is applied to the emission control line ELi, the transistors T15 and T16 are turned off, and the light emitting element LD may be prevented from unnecessarily emitting light during a voltage application process of the initialization power.

Next, a data signal DATAij for the i-th pixel PXij is applied to the data line DLj, and a scan signal having a turn-on level is applied to the scan lines SLi1 and SLi2. Hence, the transistors T12, T11, and T13 enter a state capable of conducting electricity, and the data line DLj and the first node N1 are electrically connected to each other. Therefore, a compensation voltage obtained by subtracting a threshold voltage of the transistor T11 from the data signal DATAij is applied to the second electrode (e.g., the first node N1) of the storage capacitor Cst. The storage capacitor Cst may maintain a voltage corresponding to a difference between the voltage of the first driving power VDD and the compensation voltage. Such a period may be referred to as a threshold voltage compensation period or a data write period.

Furthermore, in a case in which the scan line SLi4 is an i-th scan line, the transistor T17 is turned on, so that the anode of the light emitting element LD and the third power line PL3 may be connected to each other, and the light emitting element LD may be initialized to the amount of charges corresponding to the difference between the voltage of the initialization power VINT and the voltage of the second driving power VSS.

Thereafter, as an emission control signal having a turn-on level is applied to the i-th emission control line ELi, the transistors T15 and T16 may conduct electricity. Therefore, a driving current path that connects the first power line PL1, the transistor T15, the transistor T1l, the transistor T16, the light emitting element LD, and the second power line PL2 may be formed.

The amount of driving current that flows through the first electrode and the second electrode of the transistor T11 may be adjusted in response to the voltage maintained in the storage capacitor Cst. The light emitting element LD may emit light at a luminance corresponding to the amount of driving current. The light emitting element LD may emit light until an emission signal having a turn-off level is applied to the emission control line ELi

When the emission control signal is at a turn-on level, pixels that receive the corresponding emission control signal may be in a display state. Therefore, the period during which the emission control signal is at a turn-on level may be referred to as an emission period EP (or an emission enable period). Furthermore, when the emission control signal is at a turn-off level, pixels that receive the corresponding emission signal may be in a non-display state. Therefore, the period during which the emission control signal is at a turn-off level may be referred to as a non-emission period NEP (or an emission inhibit period).

The non-emission period NEP described with reference to FIG. 10 may correspond to preventing the pixel PXij from emitting light at an undesired luminance during the initialization period and the data write period.

While a data signal written in the pixel PXij is maintained (e.g., during one frame period), one or more non-emission periods NEP may be added. As a result, as the emission period EP is reduced, low gray scales may be effectively expressed, or motion in an image may be smoothly blur-processed.

FIG. 11 is a diagram illustrating an electronic device in accordance with an embodiment of the present disclosure.

Referring to FIG. 11, the electronic device 1000 in accordance with an embodiment of the present disclosure may output a variety of information through a display module 1140. When a processor 1110 executes an application stored in a memory 1120, the display module 1140 may provide application information to the user through a display panel 1141.

The processor 1110 may acquire an external input through an input module 1130 or a sensor module 1161, and execute an application corresponding to the external input. For example, in a case in which the user selects a camera icon (or a camera application icon) displayed on the display panel 1141, the processor 1110 may acquire a user input through an input sensor 1161-2, and activate a camera module 1171. The processor 1110 may transmit image data corresponding to an image captured by the camera module 1171 to the display module 1140. The display module 1140 may display, on the display panel 1141, an image corresponding to the captured image.

As another example, in a case in which personal information authentication is executed through the display module 1140, a fingerprint sensor 1161-1 may acquire inputted fingerprint information as input data. The processor 1110 may compare input data acquired through the fingerprint sensor 1161-1 with authentication data stored in the memory 1120, and may execute an application depending on a result of the comparison. The display module 1140 may display, on the display panel 1141, information executed according to the logic of the application. The fingerprint sensor 1161-1 may be disposed to allow for the acquisition of fingerprint information in the overall area of the display module 1140 (or the display panel 1141).

As a further example, in a case in which a music streaming icon displayed on the display module 1140 is selected, the processor 1110 may acquire a user input through the input sensor 1161-2, and activate a music streaming application stored in the memory 1120. If a music playing command is inputted in the music streaming application, the processor 1110 may activate a sound output module 1163 and provide sound information corresponding to the music playing command to the user.

A brief description of the operation of the electronic device 1000 has been provided above. Hereinafter, the configuration of the electronic device 1000 will be described in detail. Some of the components of the electronic device 1000 to be described below may be integrated into a single component, or one component to be described below may be separated into two or more components.

The electronic device 1000 may communicate with an external electronic device 2000 through a network (e.g., a short-range wireless communication network or a long-range wireless communication network). In an embodiment, the electronic device 1000 may include a processor 1110, a memory 1120, an input module 1130, a display module 1140, a power module 1150, an embedded module 1160, and an external mounted module 1170. In an embodiment, in the electronic device 1000, at least one of the foregoing components may be omitted, or one or more other components may be added. In an embodiment, some components (e.g., the sensor module 1161, an antenna module 1162, or the sound output module 1163) among the foregoing components may be integrated into another component (e.g., the display module 1140).

The processor 1110 may execute software to control at least one other component (e.g., a hardware or software component) of the electronic device 1000 connected to the processor 1110 and perform various data processing or computing operations. In an embodiment, as at least a portion of a data processing or computing operation, the processor 1110 may store a command or data received from another component (e.g., the input module 1130, the sensor module 1161, or a communication module 1173) in a volatile memory 1121, process the command or data stored in the volatile memory 1121, and store result data in a nonvolatile memory 1122.

The processor 1110 may include a main processor 1111 and an auxiliary processor 1112. The main processor 1111 may include one or more of a central processing unit (CPU) 1111-1 and an application processor (AP). The main processor 1111 may further include any one or more of a graphic processing unit (GPU) 1111-2, a communication processor (CP), and an image signal processor (ISP). The main processor 1111 may further include a neural processing unit (NPU) 1111-3. The NPU 1111-3 may be a processor specialized to process an artificial intelligence model. The artificial intelligence model may be generated by machine learning. The artificial intelligence model may include a plurality of artificial neural network layers. An artificial neural network may be, for example, a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-networks, or a combination of two or more among the foregoing networks, but is not limited thereto. The artificial intelligence model may not only include a hardware structure, but may also include an additional or substitutive software structure. At least two of the foregoing processing units and the processors may be implemented as a single integrated component (e.g., a single chip). Alternatively, the processing units and the processors may be implemented as respective independent components (e.g., a plurality of chips).

The auxiliary processor 1112 may include a controller 1112-1. The controller 1112-1 may include an interface conversion circuit and a timing control circuit. For example, the controller 1112-1 may include the timing controller 120 shown in FIG. 1. The controller 1112-1 may receive an image signal from the main processor 1111, and may convert a data format of the image signal to a format corresponding to specifications of an interface with the display module 1140 and output image data. The controller 1112-1 may output various control signals utilized to drive the display module 1140.

The auxiliary processor 1112 may further include a data conversion circuit 1112-2, a gamma correction circuit 1112-3, a rendering circuit 1112-4, a touch control circuit, etc. The data conversion circuit 1112-2 may receive image data from the controller 1112-1, compensate for the image data to display an image at a desired luminance based on characteristics of the electronic device 1000 or settings of the user, or may convert the image data to reduce power consumption or compensate for afterimages.

For example, the data conversion circuit 1112-2 may include the degradation compensator 200 illustrated in FIG. 1. The data conversion circuit 1112-2 may generate the compensation data CDATA by reflecting the panel weights LD_age and TFT_age in the image data (or input data Din). The compensation data CDATA may be provided to the controller 1112-1.

The gamma correction circuit 1112-3 may convert image data, a gamma reference voltage, etc. so that an image to be displayed on the electronic device 1000 can have desired gamma characteristics. The rendering circuit 1112-4 may receive image data from the controller 1112-1, and render the image data taking into account, e.g., pixel arrangement on the display panel 1141 applied to the electronic device 1000.

The touch control circuit may supply a touch signal to the input sensor 1161-2, and receive a sensing signal from the input sensor 1161-2 in response to the touch signal.

At least one among the data conversion circuit 1112-2, the gamma correction circuit 1112-3, the rendering circuit 1112-4, and the touch control circuit may be integrated into another component (e.g., the main processor 1111 or the controller 1112-1). At least one among the data conversion circuit 1112-2, the gamma correction circuit 1112-3, and the rendering circuit 1112-4 may be integrated into a source driver 1143 to be described below.

The memory 1120 may store a variety of data to be used in at least one component (e.g., the processor 1110 or the sensor module 1161) of the electronic device 1000, and input data or output data for a command pertaining to the variety of data. Furthermore, the memory 1120 may store a variety of setting data corresponding to settings of the user. The memory 1120 may include at least one or more of the volatile memory 1121 and the nonvolatile memory 1122. The memory 1120 may include at least one of the memories 208 and 208a illustrated in FIGS. 5, 7, and 8.

The input module 1130 may receive a command or data to be used in a component (e.g., the processor 1110, the sensor module 1161, or the sound output module 1163) of the electronic device 1000 from an external device (e.g., the user or an external electronic device 2000) disposed outside the electronic device 1000.

The input module 1130 may include a first input module 1131 configured to receive a command or data from the user, and a second input module 1132 configured to receive a command or data from the external electronic device 2000. The first input module 1131 may include, for example, a microphone, a mouse, a keyboard, a key (e.g., a button), or a pen (e.g., a passive pen or an active pen). The second input module 1132 may support a designated protocol, which can be connected to the external electronic device 2000 in a wired or wireless manner. In an embodiment, the second input module 1132 may include, for example, a high definition multimedia interface (HDMI), a universal serial bus (USB) interface, an SD card interface, or an audio interface. The second input module 1132 may include a connector such as, for example, an HDMI connector, a USB connector, an SD card connector, or an audio connector (e.g., a headphone connector), for physical connection with the external electronic device 2000.

The display module 1140 may provide visual information to the user. The display module 1140 may include a display panel 1141, a gate driver 1142, and a source driver 1143. The display module 1140 may further include a window, a chassis, and a bracket which may protect the display panel 1141.

The display panel 1141 (or a display) may include, for example, a liquid crystal display panel, an organic light emitting display panel, or an inorganic light emitting display panel. However, the type of display panel 1141 is not limited thereto. The display panel 1141 may be, for example, a rigid type panel, or a flexible type panel, which may be rollable or foldable. The display module 1140 may further include, for example, a support, a bracket, or a heat dissipater, which may support the display panel 1141.

The display panel 1141 may receive image data from the auxiliary processor 1112, and display images while controlling the amount of current flowing from the first driving power VDD to the second driving power VSS via the pixels PX in correspondence with the image data. The display panel 1141 may correspond to the pixel component 110 illustrated in FIG. 1.

The gate driver 1142 may be mounted on the display panel 1141 as a driving chip. The gate driver 1142 may be integrated on the display panel 1141. For example, the gate driver 1142 may include an amorphous silicon TFT gate (ASG) driver circuit, a low temperature polycrystalline silicon (LTPS) TFT gate driver circuit, or an oxide semiconductor TFT gate (OSG) driver circuit, which is internalized in the display panel 1141. The gate driver 1142 may receive a control signal from the controller 1112-1, and output scan signals to the display panel 1141 in response to the control signal. The gate driver 1142 may include the scan driver 130 illustrated in FIG. 1.

The display module 1140 may further include an emission driver. The emission driver may output an emission control signal to the display panel 1141 in response to a control signal received from the controller 1112-1. The emission driver may be formed separately from the gate driver 1142, or may be integrated into the gate driver 1142.

The source driver 1143 may receive a control signal from the controller 1112-1, convert image data to an analog voltage (e.g., a data signal) in response to the control signal, and output data signals to the display panel 1141. The source driver 1143 may include the data driver 140 illustrated in FIG. 1.

The source driver 1143 may be integrated into another component (e.g., the controller 1112-1). The functions of the interface conversion circuit and the timing control circuit of the controller 1112-1 may be integrated into the source driver 1143.

The display module 1140 may further include a voltage generation circuit 1144. The voltage generation circuit 1144 may output various voltages utilized to drive the display panel 1141. For example, the voltage generation circuit 1144 may generate first driving power VDD, second driving power VSS, and initialization power VINT.

In an embodiment, the display panel 1141 may include a plurality of pixel columns, each including a plurality of pixels.

In an embodiment, the source driver 1143 may convert data that is included in image data received from the processor 1110 and corresponds to, for example, red (R), green (G), and blue (B) to a red data signal (or a data voltage), a green data signal, and a blue data signal, respectively, and provide the data signals to a plurality of pixel columns included in the display panel 1141 during a single horizontal period.

The power module 1150 may supply power to the components of the electronic device 1000. The power module 1150 may include a battery that stores power voltage. The battery may include, for example, a primary cell, which cannot be recharged, and a secondary cell or a fuel cell, which are rechargeable. The power module 1150 may include a power management integrated circuit (PMIC). The PMIC may supply optimized power to each of the foregoing modules and modules to be described below. The power module 1150 may include a wireless power transceiver that is electrically connected with the battery. The wireless power transceiver may include a plurality of coiled antenna radiators. The voltage generation circuit 1144 may be integrated with the power module 1150.

The electronic device 1000 may further include an embedded module 1160 and an external mounted module 1170. The embedded module 1160 may include a sensor module 1161, an antenna module 1162, and a sound output module 1163. The external mounted module 1170 may include a camera module 1171, a light module 1172, and a communication module 1173.

The sensor module 1161 may sense an input from the body of the user or an input from a pen of the first input module 1131, and generate an electrical signal or a data value corresponding to the input. The sensor module 1161 may include at least one or more among a fingerprint sensor 1161-1, an input sensor 1161-2, and a digitizer 1161-3.

The fingerprint sensor 1161-1 may generate a data value corresponding to the fingerprint of the user. The fingerprint sensor 1161-1 may include any one of an optical fingerprint sensor and a capacitive fingerprint sensor.

The input sensor 1161-2 may generate a data value corresponding to coordinate information of the input from the body of the user or the input from the pen. The input sensor 1161-2 may generate a data value corresponding to the amount of change in capacitance by the input. The input sensor 1161-2 may sense an input from a passive pen, or transmit or receive data to or from an active pen.

The input sensor 1161-2 may measure a biometric signal pertaining to biometric information such as, for example, a blood pressure, body fluid, or body fat. For example, in a case in which the user brings a part of his/her body into contact with the sensor layer or the sensing panel and remains stationary for a certain time, the input sensor 1161-2 may sense a biometric signal, based on a change in electric field by the part of his/her body, and output information desired by the user to the display module 1140.

The digitizer 1161-3 may generate a data value corresponding to coordinate information of an input from a pen. The digitizer 1161-3 may generate data values corresponding to electromagnetic variations caused by the input. The digitizer 1161-3 may sense an input from a passive pen, or transmit or receive data to or from an active pen.

At least one of the fingerprint sensor 1161-1, the input sensor 1161-2, and the digitizer 1161-3 may be implemented as a sensor layer formed on the display panel 1141 through a successive process. At least one among the fingerprint sensor 1161-1, the input sensor 1161-2, and the digitizer 1161-3 may be disposed over the display panel 1141. Any one among the fingerprint sensor 1161-1, the input sensor 1161-2, and the digitizer 1161-3, for example, the digitizer 1161-3, may be disposed under the display panel 1141.

At least two or more among the fingerprint sensor 1161-1, the input sensor 1161-2, and the digitizer 1161-3 may be formed to be integrated into a single sensing panel through the same process. In a case in which at least two or more among the fingerprint sensor 161-1, the input sensor 161-2, and the digitizer 161-3 are integrated into a single sensing panel, the sensing panel may be disposed between the display panel 1141 and a window disposed over the display panel 1141. In an embodiment, the sensing panel may be disposed on the window. However, the position of the sensing panel is not particularly limited.

At least one of the fingerprint sensor 1161-1, the input sensor 1161-2, and the digitizer 1161-3 may be embedded in the display panel 1141. For example, during a process of forming components (e.g., a light emitting element, a transistor, etc.) included in the display panel 1141, at least one among the fingerprint sensor 1161-1, the input sensor 1161-2, and the digitizer 1161-3 may be formed simultaneously with the components.

In addition, the sensor module 1161 may generate an electrical signal or data value corresponding to internal conditions or external conditions of the electronic device 1000. The sensor module 1161 may further include, for example, a gesture sensor, a gyroscope sensor, an atmospheric sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The antenna module 1162 may include one or more antennas to transmit or receive a signal or power to or from an external device. In an embodiment, the communication module 1173 may transmit a signal to an external electronic device or receive a signal from the external electronic device through an antenna suitable for a communication scheme. An antenna pattern of the antenna module 1162 may be integrated into a component of the display module 1140 (e.g., the display panel 1141 of the display module 1140) or the input sensor 1161-2.

The sound output module 1163 may be a device that outputs a sound signal to a device provided outside the electronic device 1000, and, for example, may include a speaker, which may be used for typical purposes such as reproducing multimedia or recorded data, and a receiver, which may be used for phone reception. In an embodiment, the receiver may be integrally or separately formed with a speaker. A sound output pattern of the sound output module 1163 may be integrated into the display module 1140.

The camera module 1171 may capture a static image or a video. In an embodiment, the camera module 1171 may include one or more lenses, an image sensor, or an image signal processor. The camera module 1171 may further include an infrared camera capable of sensing, for example, the presence of the user, the position of the user, a line of sight of the user, etc.

The light module 1172 may provide light. The light module 1172 may include a light emitting diode or a xenon lamp. The light module 1172 may be operated with the camera module 1171 or operated independently of the camera module 1171.

The communication module 1173 may form a wired or wireless communication channel between the electronic device 1000 and the external electronic device 2000, and support execution of communication through the formed communication channel. The communication module 1173 may include either or both a wireless communication module such as, for example, a cellular communication module, a short-range wireless communication module, or a global navigation satellite system (GNSS) communication module, and a wired communication module such as, for example, a local area network (LAN) communication module, or a power line communication module. The communication module 1173 may communicate with the external electronic device 2000 through a short-range communication network such as, for example BLUETOOTH, WIFI Direct or infrared data association (IrDA), or a long-range communication network such as, for example, a cellular network, an internet, or a computer network (e.g., LAN or WAN). The various types of communication modules 1173 described above may be implemented as a single chip or may be implemented as respective separate chips.

The input module 1130, the sensor module 1161, the camera module 1171, etc., utilized with the processor 1110, may be used to control the operation of the display module 1140.

The processor 1110 may output a command or data to the display module 1140, the sound output module 1163, the camera module 1171, or the light module 1172, based on input data received from the input module 1130. For example, the processor 1110 may generate image data in response to input data applied through, for example, a mouse, an active pen, etc., and output the image data to the display module 1140, or may generate command data in response to input data and output the command data to the camera module 1171 or the light module 1172. In a case in which input data is not received from the input module 1130, the processor 1110 may convert the operation mode of the electronic device 1000 to a low-power mode or a sleep mode, thus reducing the power consumption of the electronic device 1000.

The processor 1110 may output a command or data to the display module 1140, the sound output module 1163, the camera module 1171, or the light module 1172, based on sensing data received from the sensor module 1161. For example, the processor 1110 may compare authentication data applied from the fingerprint sensor 1161-1 with the authentication data stored in the memory 1120, and may execute an application depending on a result of the comparison. The processor 1110 may execute a command based on sensing data sensed by the input sensor 1161-2 or the digitizer 1161-3, or output corresponding image data to the display module 1140. In a case in which the sensor module 1161 includes a temperature sensor, the processor 1110 may receive temperature data for a measured temperature from the sensor module 1161, and further execute a luminance correction operation for the image data based on the temperature data.

The processor 1110 may receive measurement data for the presence of the user, the position of the user, a line of sight of the user, etc. from the camera module 1171. The processor 1110 may further execute a luminance correction operation for the image data based on the measurement data. For example, the processor 1110 that has determined whether the user is present through an input from the camera module 1171 may output, to the display module 1140, image data, the luminance of which is corrected by the data conversion circuit 1112-2 or the gamma correction circuit 1112-3.

Some components among the foregoing components may be connected to each other by a communication scheme such as, for example, a bus, general purpose input/output (GPIO), a serial peripheral interface (SPI), a mobile industry processor interface (MIPI), or a ultra path interconnect (UPI) link, which can be used between peripheral devices, and may thus exchange a signal (e.g., a command or data) therebetween. The processor 1110 may communicate with the display module 1140 through a predefined interface. For example, any one of the foregoing communication schemes may be used, and the interface is not limited to the foregoing communication schemes.

In a display device, a method of driving the display device, and an electronic device including the display device in accordance with embodiments of the present disclosure, compensation data may be generated by applying a panel weight including characteristics of a display panel to accumulated data. The panel weight may include estimated degradation dispersion information of a light emitting element and a driving transistor. Hence, degradation of the pixels may be reliably compensated for.

While the present disclosure has been particularly shown and described with reference to embodiments thereof, it will be understood by those of ordinary skill in the art that various changes in form and detail may be made therein without departing from the spirit and scope of the present disclosure as defined by the following claims.

What is claimed is:

1. A display device, comprising:
a display panel including a plurality of pixels;
a degradation compensator circuit configured to generate compensation data that compensates for degradation of the pixels using a panel weight including characteristics of the display panel; and
a timing controller configured to reflect the compensation data in input data and generate output data,
wherein the panel weight is generated based on fabrication data including a process variable of the display panel and module data including at least one characteristic of the pixels.

2. The display device according to claim 1, wherein the fabrication data includes at least one of a deposition time and a cleaning time of each of materials forming the pixels, an aperture ratio of the pixels, a threshold voltage of a driving transistor included in each of the pixels, and a voltage range of a data signal set during a fabrication process.

3. The display device according to claim 1, wherein the module data includes color coordinates of the pixels, a leakage slope of a driving transistor included in each of the pixels, and a luminance of the pixels.

4. The display device according to claim 1, wherein the degradation compensator circuit comprises:
a degradation accumulator configured to generate accumulated data by accumulating at least one of the input data and the output data, and generate the compensation data using the accumulated data and the panel weight; and
a memory configured to store the accumulated data and the panel weight.

5. The display device according to claim 4, wherein the degradation accumulator is configured to generate the accumulated data by accumulating at least one of the input data and the output data on a frame basis.

6. The display device according to claim 4, wherein the panel weight comprises:
a first panel weight corresponding to estimated degradation dispersion information about a light emitting element included in at least one of the pixels; and
a second panel weight corresponding to estimated degradation dispersion information about a driving transistor included in at least one of the pixels.

7. The display device according to claim 6,
wherein the degradation accumulator is configured to generate a first stress compensation weight by reflecting the first panel weight in the accumulated data, and generate a second stress compensation weight by reflecting the second panel weight in the accumulated data, and
wherein the first stress compensation weight and the second stress compensation weight are included in the compensation data.

8. The display device according to claim 7, wherein the timing controller comprises:
a first compensator configured to generate first data by reflecting the first stress compensation weight in the input data; and
a second compensator configured to generate the output data by reflecting the second stress compensation weight in the first data.

9. The display device according to claim 6, wherein the memory comprises a first memory configured to store the accumulated data, and a second memory configured to store the first panel weight and the second panel weight.

10. The display device according to claim 6, wherein the first panel weight and the second panel weight correspond to each of the pixels.

11. The display device according to claim 6,
wherein the display panel is divided into a plurality of blocks, each including at least two or more pixels, and
wherein the first panel weight and the second panel weight correspond to each of the blocks.

12. The display device according to claim 6, wherein the first panel weight is a single panel weight, the second panel weight is a single panel weight, and the first panel weight and the second panel weight correspond to all of the pixels.

13. The display device according to claim 4,
wherein the memory is configured to store a plurality of panel weights corresponding to different types of display panels, and
wherein the degradation compensator circuit further comprises a controller configured to supply at least one panel weight among the plurality of panel weights to the degradation accumulator based on the fabrication data including the process variable of the display panel and the module data including the at least one characteristic of the pixels.

14. The display device according to claim 1, further comprising:
a scan driver configured to supply a scan signal to the pixels; and
a data driver configured to generate a data signal using the output data, and supply the data signal to the pixels.

15. A display device, comprising:
a display panel including a plurality of pixels; and
a degradation compensator circuit configured to generate compensation data that compensates for degradation of the pixels,
wherein the degradation compensator circuit is configured to generate accumulated data by accumulating at least one of input data and output data, and generate compensation data by reflecting, in the accumulated data, a first panel weight corresponding to estimated degradation dispersion information about a light emitting element included in each of the pixels and a second panel weight corresponding to estimated degradation dispersion information about a driving transistor included in each of the pixels.

16. The display device according to claim 15, wherein the compensation data includes a first stress compensation weight in which the first panel weight is reflected, and a second stress compensation weight in which the second panel weight is reflected.

17. The display device according to claim 16, further comprising:
a timing controller configured to generate the output data using the input data,
wherein the timing controller comprises:
a first compensator configured to generate first data by reflecting the first stress compensation weight in the input data; and
a second compensator configured to generate the output data by reflecting the second stress compensation weight in the first data.

18. The display device according to claim 15, wherein the degradation compensator circuit further comprises a memory in which the accumulated data, the first panel weight, and the second panel weight are stored.

19. A method of driving a display device, comprising:
generating accumulated data by accumulating at least one of input data and output data;
generating a first stress compensation weight by reflecting a first panel weight including at least one characteristic of a display panel in the accumulated data;
generating a second stress compensation weight by reflecting a second panel weight including the at least one characteristic of the display panel in the accumulated data;
generating first data by reflecting the first stress compensation weight in the input data; and
generating the output data by reflecting the second stress compensation weight in the first data.

20. The method according to claim 19,
wherein the first panel weight corresponds to estimated degradation dispersion information about a light emitting element included in a pixel, and
wherein the second panel weight corresponds to estimated degradation dispersion information about a driving transistor included in the pixel.

21. The method according to claim 19, further comprising:
generating a data signal using the output data.

22. An electronic device, comprising:
a display panel including a plurality of pixels;
a controller configured to control the display panel; and
a data conversion circuit configured to generate accumulated data by accumulating at least one of input data inputted to the controller and output data outputted from the controller, and generate compensation data by reflecting a panel weight including characteristic information of the display panel in the accumulated data,
wherein the controller is further configured to generate the output data by reflecting the compensation data in the input data.

23. The electronic device according to claim 22, wherein the panel weight includes a first panel weight corresponding to estimated degradation dispersion information about a light emitting element included in each of the pixels, and a second panel weight corresponding to estimated degradation dispersion information about a driving transistor included in each of the pixels.
